(19) United States
(12) Patent Application Publication
(10) Pub. No.: US 2006/0007599 A1
(43) Pub. Date: Jan. 12, 2006

(54) System, method, and apparatus for high performance, four-piece suspension with extended hinge plate

(75) Inventor: Wing Chun Shum, San Jose, CA (US)

Correspondence Address: BRACEWELL & PATTERSON, LLP, PO BOX 61389, HOUSTON, TX, 77208-1389, US

(73) Assignee: Hitachi Global Storage Technologies Netherlands B.V., Amsterdam (NL)

(21) Appl. No.: 10/889,487

(22) Filed: Jul. 12, 2004

(51) Int. Cl. G11B 5/48; G11B 21/16

(52) U.S. Cl. 360/244.8

(57) ABSTRACT

A four-piece suspension having a separate extended hinge plate routes its flexure centrally through the hinge area in a symmetrical design. This design eliminates unwanted off-track motion of the slider for bending modes. The hinge plate extends from the base of the load beam to the base of the flexure legs to eliminate height mismatch for the flexure. The ILS flexure, hinge plate, and load beam are welded together to provide a stiff structure for high torsional frequencies. Flexure torsional mode frequency is further increased by welding the flexure to the hinge plate and load beam at two locations closer to the dimple formed at the distal end of the suspension.

### BACKGROUND OF THE INVENTION

1. Technical Field

The present invention relates in general to an improved suspension for a disk drive and, in particular, to an improved system, method, and apparatus for improving the performance of a four-piece suspension using a separate, extended hinge plate.

2. Description of the Related Art

Data access and storage systems generally comprise one or more storage devices that store data on magnetic or optical storage media. For example, a magnetic storage device is known as a direct access storage device (DASD) or a hard disk drive (HDD) and includes one or more disks and a disk controller to manage local operations concerning the disks. The hard disks themselves are usually made of aluminum alloy or a mixture of glass and ceramic, and are covered with a magnetic coating. Typically, one to five disks are stacked vertically on a common spindle that is turned by a disk drive motor at several thousand revolutions per minute (rpm). Hard disk drives have several different typical standard sizes or formats, including server, desktop, mobile (2.5 and 1.8 inches) and microdrive.

A typical HDD also uses an actuator assembly to move magnetic read/write heads to the desired location on the rotating disk so as to write information to or read data from that location. Within most HDDs, the magnetic read/write head is mounted on a slider. A slider generally serves to mechanically support the head and any electrical connections between the head and the rest of the disk drive system. The slider is aerodynamically shaped to glide over moving air in order to maintain a uniform distance from the surface of the rotating disk, thereby preventing the head from undesirably contacting the disk.

A slider is typically formed with an aerodynamic pattern of protrusions on its air bearing surface (ABS) that enables the slider to fly at a constant height close to the disk during operation of the disk drive. A slider is associated with each side of each disk and flies just over the disk's surface. Each slider is mounted on a suspension, such as an integrated lead suspension (ILS), to form a head gimbal assembly (HGA). The HGA is then attached to a semi-rigid actuator arm that supports the entire head flying unit. Several semi-rigid arms may be combined to form a single movable unit having either a linear bearing or a rotary pivotal bearing system.

A typical four-piece ILS 11 is shown in FIG. 1. ILS 11 includes a flexure 13, a slider 16, a load beam 17, a hinge plate 19, and a mount plate 21. In this design, the flexure 13 is routed completely outside of the hinge area 19 (e.g., off to one lateral side) of the suspension. With an external routing path before and after the hinge area, the ILS flexure at the hinge area is asymmetric and creates an inherent mass imbalance. Imbalances cause unwanted slider off-track motion for vibration modes in the bending direction under excitations, such as shock and windage. Thus, an improved ILS flexure design that overcomes these problems would be desirable. The most direct way to improve this asymmetric flexure routing is to change the routing of the flexure to a centralized routing through the center of the hinge area. Such a centralized routing can eliminate much of the mass imbalance produced by the flexure going outside of the hinge springs of the HGA.

Referring now to FIGS. 2 and 3, for a HGA design 11 that requires ILS flexures 13 to go through the center of the two hinge springs 2A via the opening in the hinge plate 2B, the flexure 13 undergoes a change in elevation 15 or height as they extend along the length of the HGA between locations 13A and 13B on the flexure 13. The reason for the change in elevation 15 is that at location 13A, the flexure 13 is welded on the surface of the load beam 3. This load beam surface is at the same level as the top surface of the mount plate 4. The flexure then goes between the center of the two hinge springs 2A of the hinge plate 2. It is then welded on top of the hinge plate 2 at flexure location 13B. The top surface of the hinge plate is higher than the top surface of the load beam by the thickness of the hinge plate, which is typically about 0.025 mm to 0.050 mm.

The change in elevation 15 is an undesirable bend in the structure of the flexure 13 that is required to go from a relative height of the load beam 3 to that of the hinge plate 2 on the mount plate 4. Such a bend puts a mechanical moment in the flexure 13, which can twist the HGA at the hinge springs 2A. This twist can increase the off-track motion of the slider under excitation, such as windage or any other external vibration in the file. It can be detrimental to the performance of the device.

### SUMMARY OF THE INVENTION

One embodiment of a system, method, and apparatus for improving the performance of a four-piece suspension having a separate, extended hinge plate is disclosed. The present invention comprises an ILS flexure that is centrally-routed through the hinge area of the suspension and, in one version, is completely symmetrical. This design eliminates many of previously described problems associated with the prior art, including much of the unwanted off-track motion of the slider for bending modes. By extending the hinge plate from the base of the load beam to the base of the flexure legs, any height mismatch for the flexure is completely eliminated. The ILS flexure, hinge plate, and load beam may be welded together to provide a stiff structure for high torsional frequencies. Flexure torsional mode frequency is further increased by welding the flexure to the hinge plate and load beam at two locations closer to the dimple formed at the distal end of the suspension.

The foregoing and other objects and advantages of the present invention will be apparent to those skilled in the art, in view of the following detailed description of the present invention, taken in conjunction with the appended claims and the accompanying drawings. For example, other types of suspensions (e.g., wireless suspensions, CIS, etc.) that employ a four-piece construction also benefit from the present invention.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is an isometric view of a conventional four-piece suspension;

FIG. 2 is an isometric view of a conventional suspension requiring a change in the elevation of the flexure;

FIG. 3 is an isometric view of a hinge plate for the conventional suspension of FIG. 2;

FIG. 4 is an isometric view of one embodiment of a suspension constructed in accordance with the present invention;

FIG. 5 is a sectional side view of the suspension of FIG. 4 and is constructed in accordance with the present invention;

FIG. 6 is an isometric view of a hinge plate for the suspension of FIG. 4 and is constructed in accordance with the present invention; and

FIG. 7 is a schematic plan view of a disk drive that utilizes the suspension of FIG. 4 and is constructed in accordance with the present invention.

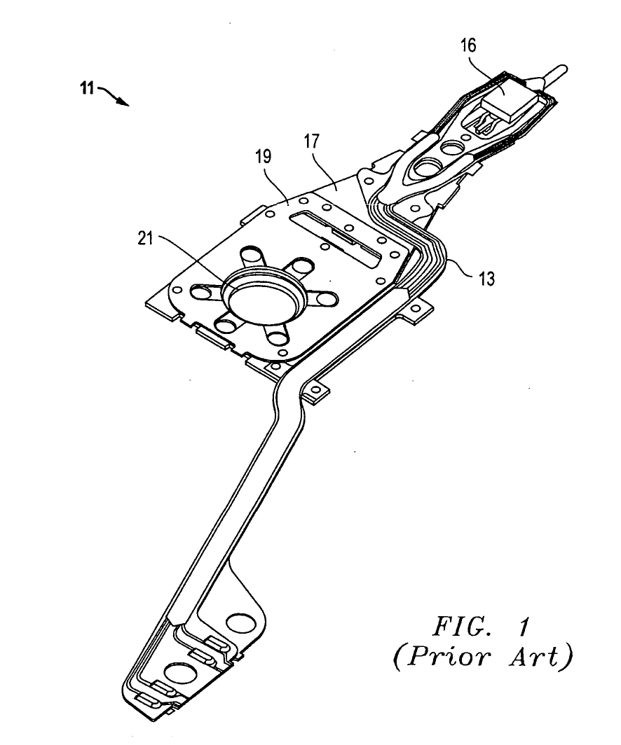

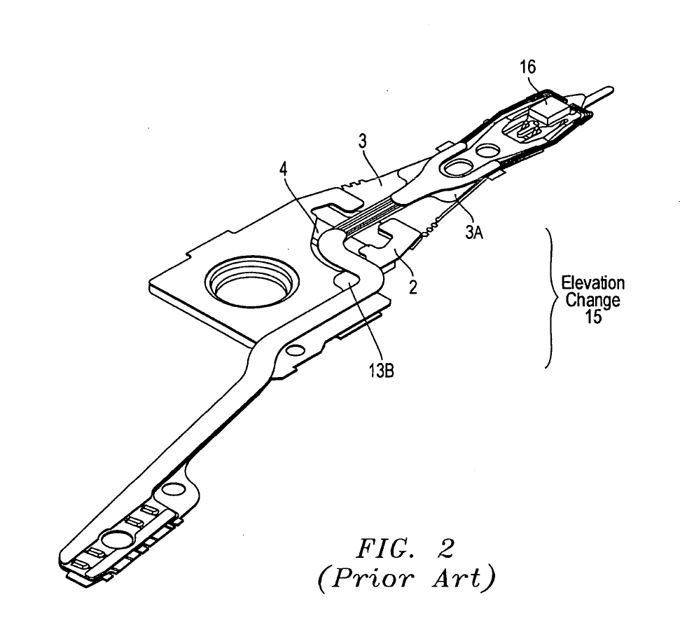

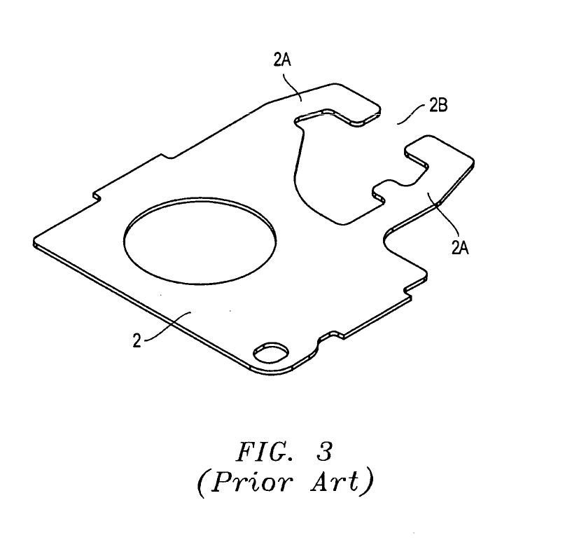

### DETAILED DESCRIPTION OF THE INVENTION

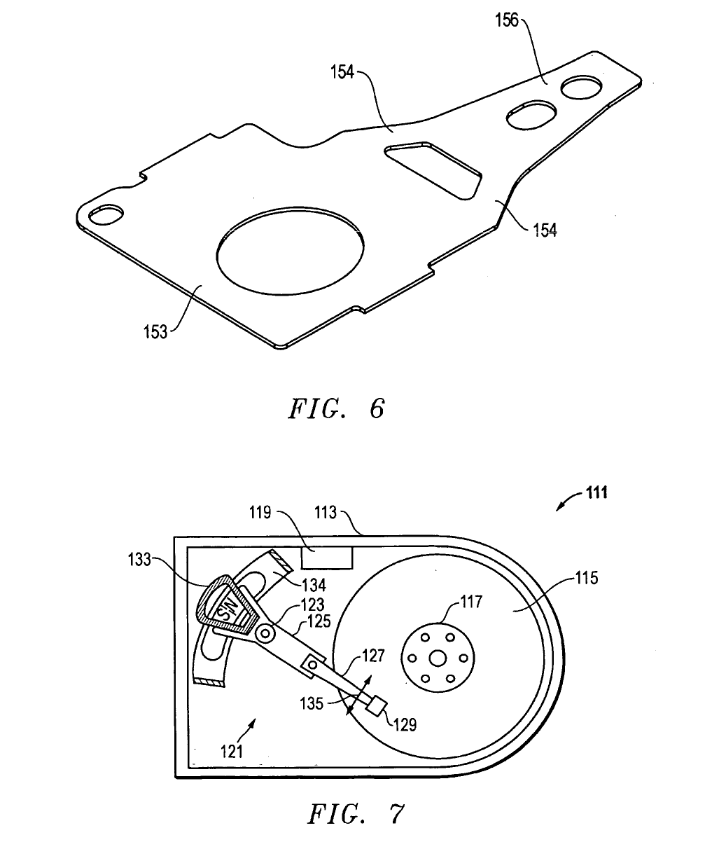

Referring now to FIG. 7, a schematic drawing of one embodiment of an information storage system comprising a magnetic hard disk file or drive 111 for a computer system is shown. Drive 111 has an outer housing or base 113 containing at least one magnetic disk 115. Disk 115 is rotated by a spindle motor assembly having a central drive hub 117. An actuator 121 comprises a plurality of parallel actuator arms 125 (one shown) in the form of a comb that is pivotally mounted to base 113 about a pivot assembly 123. A controller 119 is also mounted to base 113 for selectively moving the comb of arms 125 relative to disk 115.

In the embodiment shown, each arm 125 has extending from it at least one of the suspensions 127. A magnetic read/write transducer or head is mounted on a slider 129 and secured to the flexure that is flexibly mounted to each suspension 127. The read/write heads magnetically read data from and/or magnetically write data to disk 115. The level of integration called the head gimbal assembly is head and the slider 129, which are mounted on suspension 127. The slider 129 is usually bonded to the end of suspension 127. The head is typically pico size (approximately 1250×1000×300 microns) and formed from ceramic or intermetallic materials. The head also may be femto size (approximately 850×700×230 microns), Pemto size (approximately 1250×700×230 microns), or even smaller in size. The head is pre-loaded against the surface of disk 115 (e.g., in the range two to ten grams) by suspension 127.

The hinge of the suspension 127 has a spring-like quality which biases or urges the air bearing surface of the slider 129 against the disk 115 to enable the creation of the air bearing film between the slider 129 and disk surface. A voice coil 133 housed within a conventional voice coil motor magnet assembly 134 (top pole not shown) is also mounted to arms 125 opposite the head gimbal assemblies. Movement of the actuator 121 (indicated by arrow 135) by controller 119 moves the head gimbal assemblies radially across tracks on the disk 115 until the heads settle on their respective target tracks. The head gimbal assemblies operate in a conventional manner and always move in unison with one another, unless drive 111 uses multiple independent actuators (not shown) wherein the arms can move independently of one another.

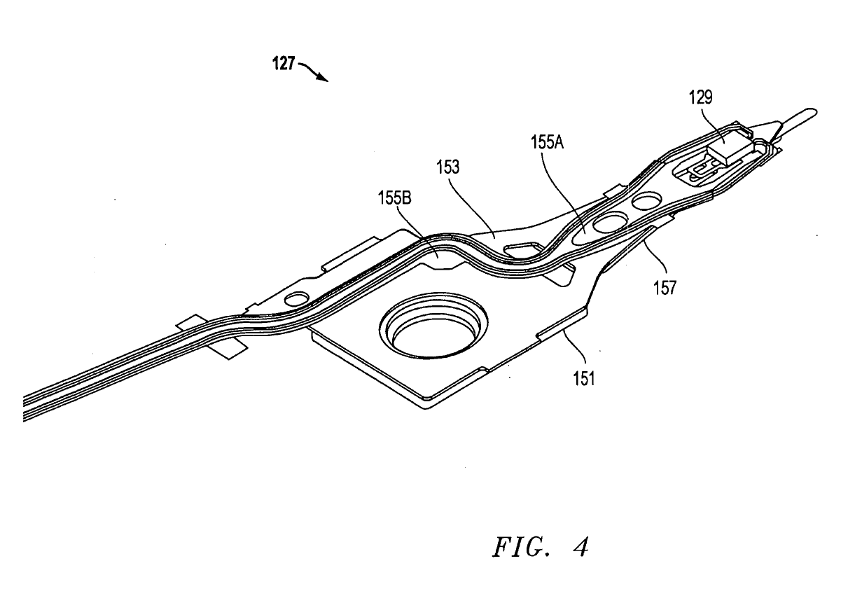

Referring now to FIGS. 4-6, one embodiment of a suspension 127 constructed in accordance with the present invention is shown. The suspension 127 comprises four primary components, including a mount plate 151, a hinge plate 153, a flexure 155, and a load beam 157. The arm 125 to which suspension 127 is mounted defines a longitudinal direction that extends radially relative to the axis of the pivot 123, and a lateral direction that is transverse to the longitudinal direction.

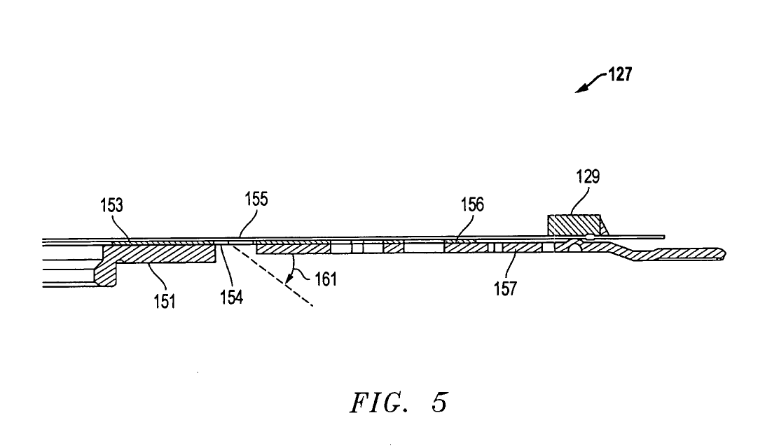

The mount plate 151 is mounted to the arm 125 and extends in the longitudinal direction to define a first plane. The hinge plate 153 is mounted to the mount plate 151 and also extends in the longitudinal direction. As shown in FIG. 6, the planar hinge plate 153 has an extension 156 that protrudes from its symmetric hinge springs 154. The extension 156 is part of the hinge springs 154 and provides a mounting location for the load beam 157. The load beam 157 is mounted to the hinge plate 153 and extends in the longitudinal direction to define a second plane. The first and second planes may be co-planar (as shown in FIG. 5), or they may intersect each other at an offset angle 161 whose apex is located in the hinge region provided by hinge plate 153.

The flexure 155 is mounted to the load beam 157 and extends in the longitudinal direction. The read/write transducer 129 is mounted to the flexure 155 for reading data from and writing data to the magnetic media 115. The flexure defines and extends in a configuration that is parallel to the first and second planes. Thus, the flexure 155 may lie in a single plane (e.g., from flexure area 155A to 155B in FIG. 4), or may incorporate the offset angle 161 (FIG. 5) to remain parallel to the first and second planes.

However, flexure 155 has no distortions that form mechanical moments therein. The plane defined by the flexure 155 extends from the mount plate 151 to the read/write transducer 129 to reduce undesirable off-track motion of the read/write transducer 129 relative to media tracks on the magnetic media 105. Furthermore, the flexure 155 may extend symmetrically down a lateral center of the hinge plate 153 and the load beam 157 to the read/write transducer 129.

The present invention has several advantages, including the ability to eliminate many of the problems associated with the prior art, such as the unwanted off-track motion of the slider for bending modes. Height mismatch for the flexure is eliminated by extending the hinge plate from the base of the load beam to the base of the flexure legs. The welded ILS flexure, hinge plate, and load beam provide a stiff structure for high torsional frequencies.

While the invention has been shown or described in only some of its forms, it should be apparent to those skilled in the art that it is not so limited, but is susceptible to various changes without departing from the scope of the invention. For example, other types of suspensions (e.g., wireless suspensions, CIS, etc.) that employ a four-piece construction also benefit from the present invention.

What is claimed is:

1. A suspension, comprising:
a mount plate extending in a longitudinal direction;
a hinge plate mounted to the mount plate and extending in the longitudinal direction;
a load beam mounted to the hinge plate and extending in the longitudinal direction; and
a flexure mounted to the load beam and extending in the longitudinal direction, the flexure defining and extending in a plane that is parallel to the mount plate and the load beam to reduce undesirable off-track motion of a read/write transducer relative to media tracks.

2. The suspension of claim 1, wherein the mount plate defines a first plane, the load beam defines a second plane that is at an offset angle with respect to the first plane, and the flexure extends in a plane that is parallel to both the first and second planes.

3. The suspension of claim 1, wherein the flexure extends symmetrically through a lateral center of the hinge plate and the load beam.

4. The suspension of claim 1, wherein the hinge plate comprises a portion mounted to the mount plate, a hinge plate extension extending to the load beam, and a hinge spring located between said portion and the hinge plate extension.

5. The suspension of claim 4, wherein the hinge plate extension is not part of the hinge spring and only provides a mounting location for the load beam.

6. The suspension of claim 1, wherein the suspension is an integrated lead suspension.

7. A hard disk drive, comprising:
an enclosure;
a disk rotatably mounted to the enclosure and having a magnetic media; and
an actuator assembly, comprising:
a comb having a pivot with an axis, a coil for a voice coil motor on one side of the pivot, and an arm extending from the comb opposite the coil, the arm defining a longitudinal direction that extends radially relative to the axis, and a lateral direction that is transverse to the longitudinal direction;
a mount plate mounted to the arm and extending in the longitudinal direction, the mount plate defining a first plane;
a hinge plate mounted to the mount plate and extending in the longitudinal direction;
a load beam mounted to the hinge plate and extending in the longitudinal direction, the load beam defining a second plane that is at an offset angle with respect to the first plane;
a flexure mounted to the load beam and extending in the longitudinal direction;
a read/write transducer mounted to the flexure for reading data from and writing data to the magnetic media; and
the flexure defining and extending in a plane that is parallel to both the first and second planes, and the planes extending from the mount plate to the read/write transducer to reduce undesirable off-track motion of the read/write transducer relative to media tracks on the magnetic media.

8. The hard disk drive of claim 7, wherein the flexure extends symmetrically through a lateral center through the hinge plate and the load beam to the read/write transducer.

9. The hard disk drive of claim 7, wherein the hinge plate comprises a portion mounted to the mount plate, a hinge plate extension extending to the load beam, and a hinge spring located between said portion and the hinge plate extension.

10. The hard disk drive of claim 9, wherein the hinge plate extension is not part of the hinge spring and only provides a mounting location for the load beam.

11. The hard disk drive of claim 7, wherein the actuator assembly utilizes an integrated lead suspension.

12. A method of reducing undesirable off-track motion of read/write transducers relative to media tracks in disk drives, the method comprising:
(a) providing a disk drive with an actuator assembly having a mount plate, a hinge plate, a load beam, a flexure, and a read/write transducer;
(b) mounting the flexure on the actuator assembly in a longitudinal direction from the mount plate to the read/write transducer; and
(c) orienting the flexure in a plane that is parallel to the mount plate and the load beam, the plane extending from the mount plate to the read/write transducer.

13. The method of claim 12, wherein step (c) comprises symmetrically positioning the flexure through a center of the hinge plate such that the flexure laterally bisect the hinge plate, the load beam, and the flexure.

14. The method of claim 12, wherein the actuator assembly utilizes an integrated lead suspension.
